(19) United States
(12) Patent Application Publication
(10) Pub. No.: US 2025/0337839 A1
(43) Pub. Date: Oct. 30, 2025

(54) MULTIPLE ROUTING SYSTEMS

(71) Applicant: Wells Fargo Bank, N.A., San Francisco, CA (US)

(72) Inventors: Mikhail Shimberg, Walnut Greek, CA (US); Srinivasa Gupta Vudathv, Chandler, AZ (US); Charles A. Langston, Indian Trail, NC (US)

(21) Appl. No.: 19/181,745

(22) Filed: Apr. 17, 2025

Related U.S. Application Data
(60) Provisional application No. 63/638,064, filed on Apr. 24, 2024.

(51) Int. Cl. H04M 3/523; H04M 3/436

(52) U.S. Cl. CPC H04M 3/523; H04M 3/4365

(57) ABSTRACT

Systems and techniques may generally be used to exchange data across multiple routing platforms. An example technique may include receiving, at a routing platform, an ongoing voice call, generating an interaction identifier associated with a user and the ongoing call, collecting ongoing voice call information, retrieving, using the ongoing voice call information, a user data record from a records data storage, identifying a target routing platform, and sending a voice stream corresponding to the ongoing voice call to the target routing platform. The target routing platform may include a routing target.

### BACKGROUND

Contact centers are widely used in many industries. For example, a customer may call to a call center of a customer service and be connected to an agent. In order to route the customer's call to the agent, the contact center uses an interaction routing system. Routing the customer's call to the right agent may be difficult in certain situations (e.g., the right agent is within another call center, the call center is experiencing high volume, or the like). As a result, some calls from customers are unable to be connected to the right agent or wait times are high.

### BRIEF DESCRIPTION OF THE SEVERAL VIEWS OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a schematic diagram of elements of a multiple interaction routing system according to various examples.

FIG. 2 is a diagram showing a workflow that may be executed, for example, in the environment of FIG. 1, according to various examples.

FIG. 3 is a diagram showing a workflow that may be executed, for example, in the environment of FIG. 1, according to various examples.

FIGS. 4-5 illustrate flowcharts including techniques for exchanging data across different routing platforms in accordance with various examples.

FIG. 6 is a block diagram illustrating a machine in the example form of a computer system, within which a set or sequence of instructions may be executed to cause the machine to perform any one or more of the techniques discussed herein, according to various examples.

### DETAILED DESCRIPTION

The systems and techniques described herein may be used for exchanging data across different routing platforms through one or more public carriers. The systems and techniques described herein provide security to the connection between multiple routing platforms (e.g., avoiding an external player from interfering or intercepting the connection) even when there is no dedicated connection between the multiple routing platforms and the public carriers. For example, a technique may include a customer calling a toll-free number (TFN) and being redirected to a correct routing platform among multiple routing platforms available. The systems and techniques described herein improve customer experience by making user interaction seamless across two or more routing platforms independent from each other, each platform having similar or different kinds of technology from each other (e.g., products by Genesys Cloud Services, Inc., Cisco® Unified Contact Center Enterprise, or the like).

Throughout this disclosure, components may take electronic actions in response to different variable values (e.g., thresholds, user preferences, or the like). As a matter of convenience, this disclosure does not always detail where the variables are stored or how they are retrieved. In such instances, it may be assumed that the variables are stored on a storage device (e.g., RAM, cache, hard drive, cloud) accessible by the component via an API or other program communication method. Similarly, the variables may be assumed to have default values should a specific value not be described. User interfaces may be provided for an end-user or administrator to edit the variable values in some instances.

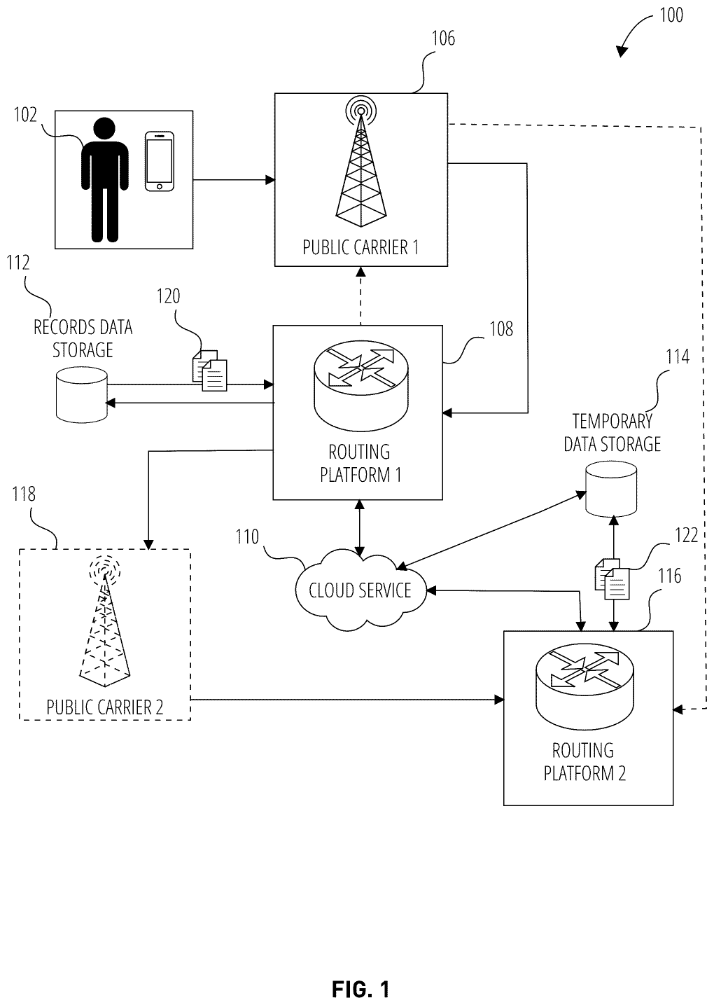

FIG. 1 illustrates a schematic diagram 100 of elements of a multiple interaction routing system. The schematic diagram 100 may be used for exchanging data across multiple routing platforms in accordance with various embodiments. The schematic diagram 100 includes a user 102, a public carrier 106, a first routing platform 108, a second routing platform 116, a records data storage 112, a temporary data storage 114, a cloud service 110, and an optional second public carrier 118.

In various examples, the user 102 calls a toll-free number (TFN) and is connected to the first routing platform 108 through the public carrier 106. The first routing platform 108 generates an interaction identifier for a combination of the user 102 and the ongoing voice call. The first routing platform 108 may collect information related to the ongoing voice call. The first routing platform 108 may identify and authenticate the user 102, for example, based on a user account number.

The first routing platform 108 may determine a user intent, query, problem, question, action, or the like. This determination may be done using a live agent or an automated system (e.g., via prompts or by collecting information from a connected app or account, etc.). The collected information may include a full name, an address, a card number (e.g., four last digits of a credit card), card type, an email address, a phone number, a reason for the interaction (e.g., the reason for the user to be calling), or the like. The collected information may be used for authenticating a user or determining an intent of the user.

Using the collected information, the first routing platform 108 may retrieve user data 120 from records data storage 112. The first routing platform 108 may use the collected information, the user data 120, agent availability, agent applicability to the determination, or the like, to determine a routing target. Before the ongoing voice call is delivered to a routing target, the first routing platform 108 determines whether the routing target is located within the first routing platform 108 or within another routing platform.

In order to make this determination, the first routing platform 108 may send a request for a target status to one or more routing platforms (e.g., second routing platform 116) through the cloud service 110. The one or more routing platforms and the first routing platform 108 may be independent of each other and may use similar or completely different technology from each other. Each routing platform of the one or more routing platforms (e.g., second routing platform 116) may return a current target status to the first routing platform 108 through the cloud service 110. The first routing platform 108 determines the target routing platform using the one or more target status received from each routing platform.

In an example, the first routing platform 108 sends a request for target status to the second routing platform 116 through the cloud service 110, for example, via an application programming interface (API). The second routing platform 116 returns a current target status to the first routing platform 108 through the cloud service 110. The first routing platform 108 determines that the second routing platform 116 is the target routing platform. As a result of the determination, the first routing platform 108 affiliates the user data 120 and other data (e.g., retrieved during the ongoing voice call, such as authentication data, account number, user ID, language selection, or the like) to the interaction ID. The data affiliated with the interaction ID may be sent to the temporary data storage 114, for example, through the cloud service 110, for example, via an API. The cloud service 110 may forward a data request to the second routing platform 116. The second routing platform 116 may create a temporary data record 122 based on the forwarded data request identified by the interaction ID on the temporary data storage 114. The second routing platform 116 may send a confirmation that the temporary data record 122 was created to the cloud service 110 (e.g., via an API), which may confirm to the first routing platform 108 that the data record was created. The temporary data storage 114 may be located in an external cloud service or within the second routing platform 116, for example.

The first routing platform 108 may route a voice stream including the interaction ID to the first public carrier 106 or through the optional second public carrier 118 to the second routing platform 116. In an example, the first routing platform 108 may route a voice stream including an automated number identifier (ANI) and a customer account number to the first public carrier 106 or through the optional second public carrier 118 to the second routing platform 116. An interaction handler of the second routing platform 116 may accept the voice stream and extract the interaction ID.

In various examples, the second routing platform 116 requests the temporary data record 122 from temporary data storage 114 using the interaction ID and, optionally, a user Automated Number Identifier (ANI) corresponding to the ongoing voice call. The ANI may be the number from which the ongoing voice call was dialed. The second routing platform 116 receives the temporary data record 122 from the temporary data storage 114.

The combination of two or more unique identifiers (e.g., customer number, user ID, etc.) within the temporary data record 122 may be used by the second routing platform 116 to confirm that the routed user interaction (e.g., the voice stream) corresponds to the ongoing call.

After the confirmation, the second routing platform 116 may associate the temporary data record 122 and the voice stream of the ongoing voice call, all of which are associated with the interaction ID. The second routing platform 116 may determine a routing target within the second routing platform 116 to route the ongoing voice call. The second routing platform 116 may route the ongoing voice call and the temporary data record 122 to the routing target. The routing target may be connected with the user 102. In an example, the second routing platform 116 sends a request to remove the temporary data record 122 from the temporary data storage 114. The temporary data storage 114 may delete the temporary data record 122 and may send a confirmation that the temporary data record 122 was deleted to the second routing platform 116.

In various examples, the first routing platform 108, using the one or more target status received from each routing platform, determines that the routing target is located within the first routing platform 108. In response to the determination, the ongoing voice call is routed to a routing target within first routing platform 108.

A user interaction (e.g., voice interaction) may be initiated at any routing platform of the schematic diagram 100.

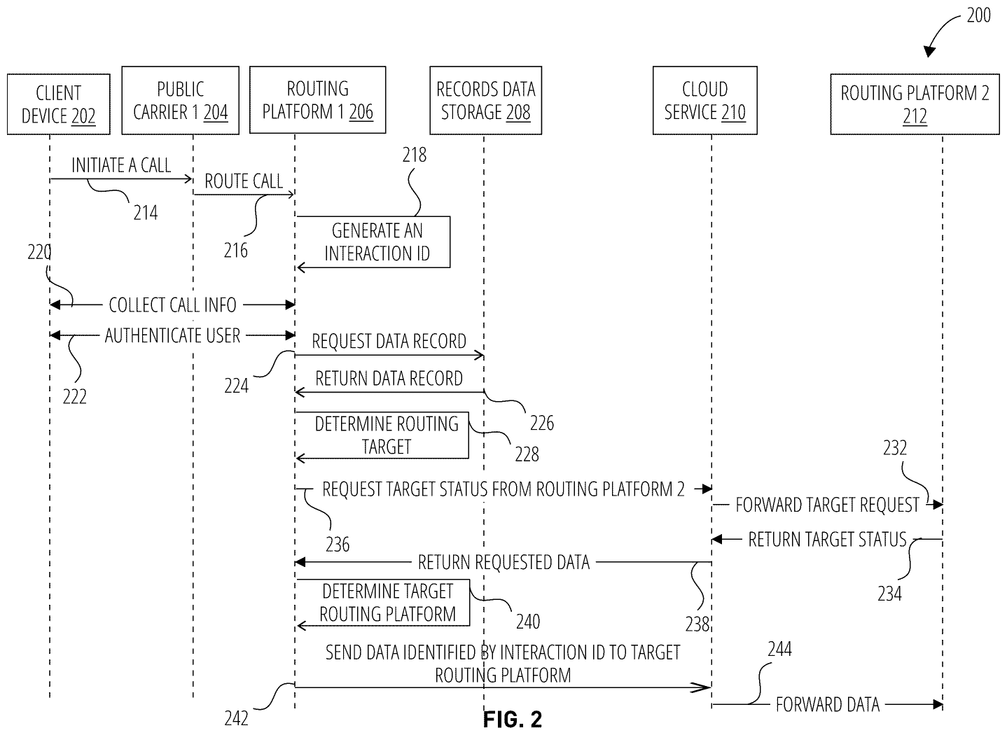

FIG. 2 is a diagram showing one example of a workflow 200 that may be executed, for example, in the environment of FIG. 1, for exchanging data across multiple independent routing platforms, according to various examples.

FIG. 2 includes a client device 202, a public carrier 204, a routing platform 206, records data storage 208, a cloud service 210, and a routing platform 212.

In various examples, a user initiates a user interaction (e.g., the user calls a toll-free number (TFN), or the like) from the client device 202 (e.g., a telephone device, computer device, smartwatch, tablet, or the like). The user interaction may be a voice interaction or any other media interaction (e.g., a chat, or the like).

When the user interaction is a voice call, the ongoing voice call may be routed 216 to the routing platform 206 through the public carrier 204. As routing platform 206 receives the ongoing voice call, the routing platform 206 generates an interaction identifier 218 associated with the ongoing voice call.

In an example, the routing platform 206 collects information of the ongoing voice call 220 and, using the collected information, uniquely identifies and authenticates (e.g., 222) the user. The routing platform 206 retrieves user data based on the identified user by sending a request for a user data record 224 to the records data storage 208 and receiving the user data record 226.

In various examples, the routing platform 206 determines the routing target 228. After determining the routing target 228, the routing platform 206 sends a request for target status to one or more routing platforms (e.g., request 236 to the cloud service 210, which may be forwarded to the routing platform 212 via request 232) through the cloud service 210 (e.g., via an API). The routing platform 212 sends the requested target status to the routing platform 206 through cloud service 210 (e.g., 234 and 238). The routing platform 206, using the received target status, determines the target routing platform 240 and sends the user data associated with the interaction identifier to the target routing platform (e.g., routing platform 212). The routing platform 206 may optionally send data identified by the interaction ID 242 to the cloud service 210 (e.g., via an API), and the cloud service 210 (e.g., via an API), and the cloud service 210 may forward the data 244 to the routing platform 212.

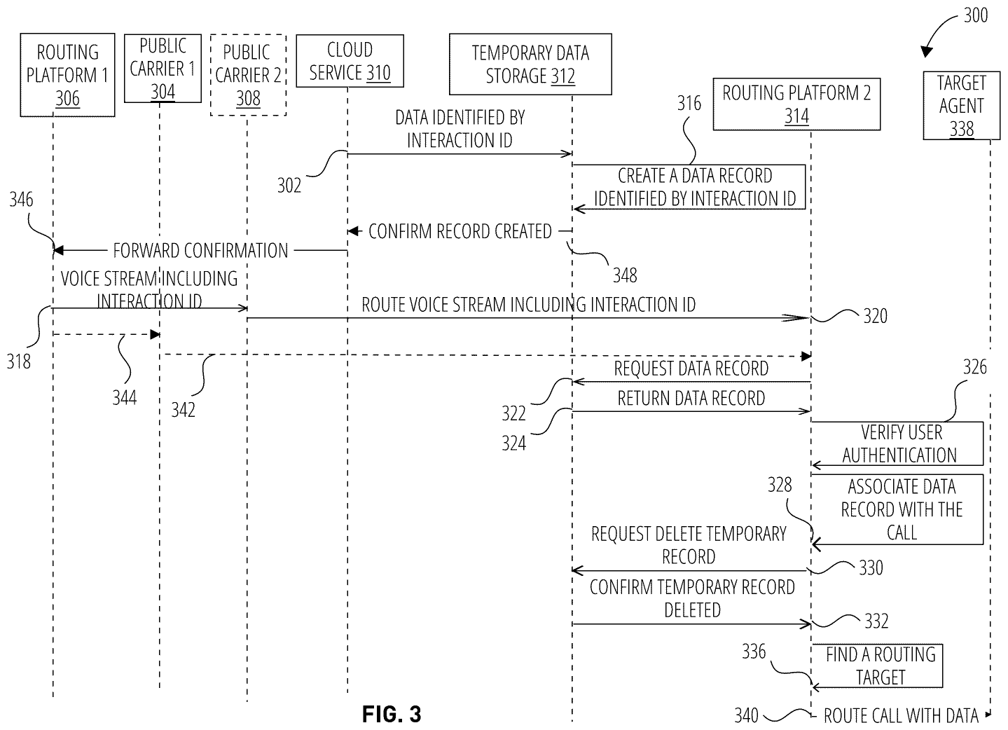

FIG. 3 is a diagram showing an example of workflow 300 that may be executed in the environment of FIG. 1 for exchanging data across multiple independent routing platforms, according to various examples. The diagram includes a first routing platform 306, a public carrier 304, a public carrier 308, a cloud service 310, a temporary data storage 312, a second routing platform 314, and a routing target 338.

In an example, the temporary data storage 312 receives user data associated with the interaction ID 302. The temporary data storage 312, using the received user data, creates a data record identified by the interaction ID 316 and sends a confirmation that the data record was created (348) to the first routing platform 306 through the cloud service 310 (confirmation 346).

In various examples, the first routing platform 306 routes a voice stream associated with an ongoing call (e.g., initiated call 214, shown in FIG. 2) to a second routing platform 314, the voice stream including the interaction ID. In an example, the first routing platform 306 routes the voice stream to the second routing platform 314 through a public carrier, such as public carrier 308 (318 and 320), public carrier 304 (344 and 342), or the like.

After receiving the voice stream, the second routing platform 314 sends to the temporary data storage 312 a request for the data record associated with the interaction ID 322. In response to the request, the temporary data storage 312 sends the data record 324 to the second routing platform 314. The second routing platform 314 verifies whether the received voice stream corresponds to the received data record 326. In confirming that the received voice stream is the correct one, second routing platform 314 associates the data record with the ongoing voice call 328.

The second routing platform 314 sends a request 330 to the temporary data storage 312 to delete the temporary data record. After deleting the temporary data record, the temporary data storage 312 sends a confirmation 332 that the temporary data record was deleted to the second routing platform 314.

The second routing platform 314 determines a routing target 338 (e.g., a live agent, a chatbot, a voicemail) and routes the ongoing voice call and the data record 340 to the routing target 338.” The routing target 338 may include an artificial intelligence agent (AI agent), a voicemail, a human agent, or the like. The routing target may be determined based on skills requirements (e.g., skill based routing).

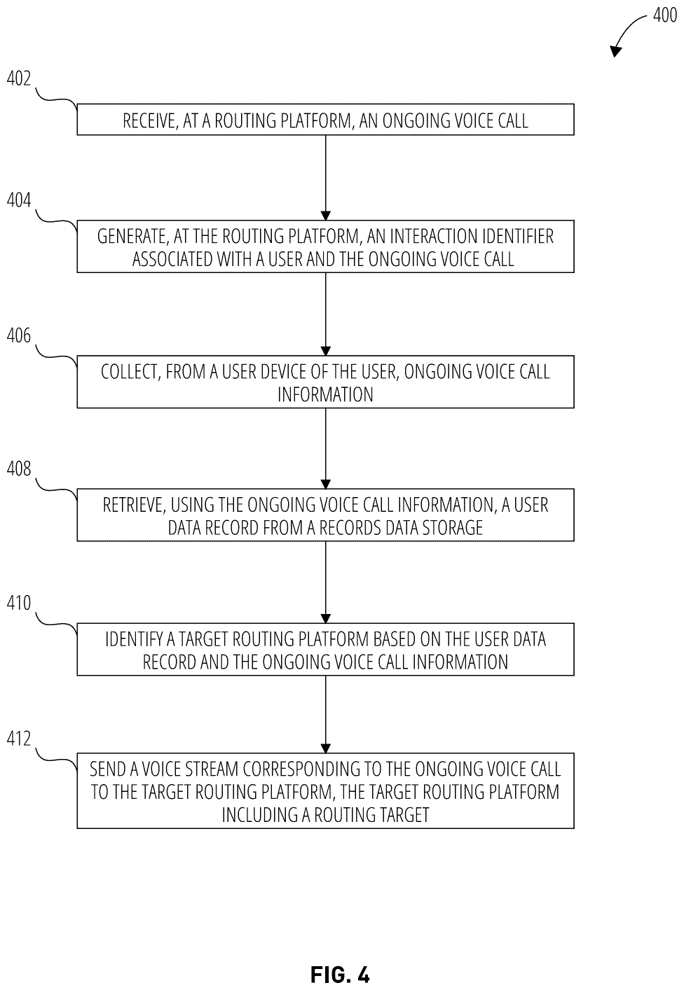

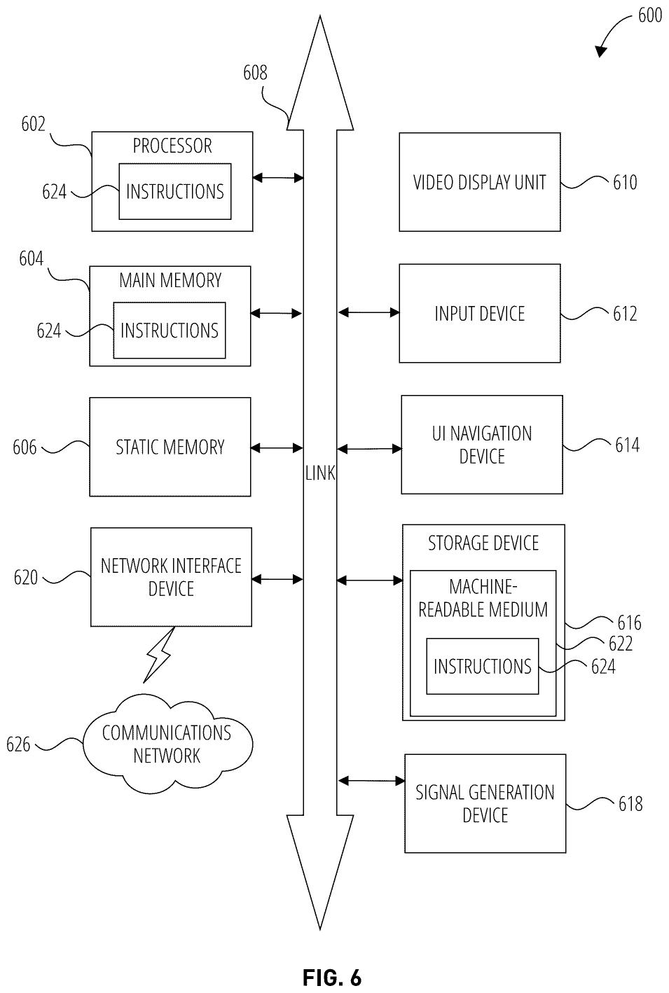

FIG. 4 is a flowchart illustrating a technique 400, according to various examples. In an example, operations of technique 400 may be performed by processing circuitry, for example, by executing instructions stored in memory. The processing circuitry may include a processor, a system on a chip, or other circuitry (e.g., wiring). For example, technique 400 may be performed by processing circuitry of a device (or one or more hardware or software components thereof), such as those illustrated and described with reference to FIG. 6.

The technique 400 includes an operation 402 to receive, at a routing platform, an ongoing voice call.

The technique 400 includes an operation 404 to generate, at the routing platform, an interaction identifier associated with a user and the ongoing voice call.

The technique 400 includes an operation 406 to collect, from a user device of the user, ongoing voice call information. In an example, collecting ongoing voice call information includes collecting information using a chatbot. In an example, technique 400 collects information from a connected app or account in a user device. The collected information may include a full name, an address, a card number (e.g., four last digits of a credit card), card type, an email address, a phone number, a reason for the interaction (e.g., the reason for the user to be calling), or the like. Technique 400 may include an operation to use the collected information for authenticating a user or for determining an intent of the user.

Technique 400 may include an operation to identify, using the ongoing voice call information, the user, wherein identify the user includes identify a user account number and a user intent.

The technique 400 includes an operation 408 to retrieve, using the ongoing voice call information, a user data record from a records data storage. In an example, before retrieving the user data record from the records storage, technique 400 authenticates the user based on the ongoing voice call information.

The technique 400 includes an operation 410 to identify a target routing platform based on the user data record and the ongoing voice call information. The technique 400 may include an operation to send status requests for routing target statuses to a plurality of routing platforms; and receive a plurality of routing target statuses, each routing target status of the plurality of routing target statuses corresponding to a respective routing platform of the plurality of routing platforms, wherein identifying the target routing platform is further based on the plurality of routing target statuses. Technique 400 may include an operation to send the user data record of the user to the target routing platform.

The technique 400 includes an operation 412 to send a voice stream corresponding to the ongoing voice call to the target routing platform, the target routing platform including a routing target. The routing target may include an artificial intelligence agent, a human agent, or a voicemail. Receiving, at the routing platform, the ongoing voice call may be via a first public carrier, and sending the voice stream corresponding to the ongoing voice call to the target routing platform may be via a second public carrier. Technique 400 may, before sending the voice stream to the target routing platform, receive a confirmation that a data record identified by the interaction identifier was created at a temporary data storage.

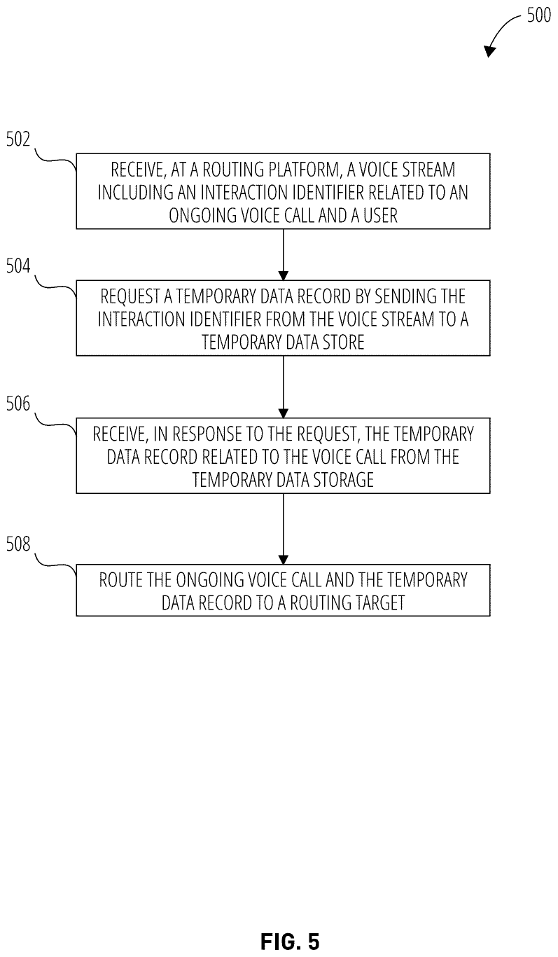

FIG. 5 is a flowchart illustrating a technique 500, according to various examples. In an example, operations of technique 500 may be performed by processing circuitry, for example, by executing instructions stored in memory. The processing circuitry may include a processor, a system on a chip, or other circuitry (e.g., wiring). For example, technique 500 may be performed by processing circuitry of a device (or one or more hardware or software components thereof), such as those illustrated and described with reference to FIG. 6.

The technique 500 includes an operation 502 to receive, at a routing platform, a voice stream including an interaction identifier related to an ongoing voice call and a user. In an example, the routing platform receives the voice stream from a second routing platform through a public carrier. The second routing platform may be the routing platform where the ongoing voice call was initiated. In various examples, the routing platform sends a current target status to the second routing platform. The second routing platform may determine a target routing platform using the received current target status.

The technique 500 includes an operation 504 to request a temporary data record by sending the interaction identifier from the voice stream to a temporary data store. In various examples, requesting a temporary data record includes sending an automated number identifier related to the ongoing voice call to the temporary data storage.

The technique 500 includes an operation 506 to receive, in response to the request, the temporary data record related to the voice call from the temporary data storage. The technique 500 may include an operation to, after receiving the temporary data record, authenticate the user, using one or more parameters of the temporary data record, and associate, in response to authenticating the user, the temporary data record with the ongoing voice call. The technique 500 may include an operation to confirm that the received voice stream corresponds to the ongoing voice call. The technique 500 may authenticate the user or confirm that the received voice stream corresponds to the ongoing voice call without using the interaction identifier.

In an example, the communication between the temporary data store and the routing platform uses a read and delete function (e.g., after receipt of the temporary data record related to the voice call by the second routing platform, the temporary data record is automatically deleted from the temporary data storage). The temporary data store may send a notification that the data record was deleted to the routing platform after the temporary data record is automatically deleted from the temporary data storage. In an example, the second routing platform, after receiving the temporary data record, sends a request to the temporary data storage to delete the temporary data record from the temporary data storage. In response to the request, the temporary data storage may delete the temporary data record and send a confirmation that the temporary data record was deleted to the second routing platform.

In some examples, in response to confirming that the received voice stream corresponds to the ongoing voice call, the technique 500 associates the ongoing voice call with the temporary data record.

The technique 500 includes an operation 508 to route the ongoing voice call and the temporary data record to a routing target. The routing target may include an artificial intelligence agent, a human agent, or a voicemail. The technique 500 may include an operation to determine the routing target based, at least in part, on the temporary data record.

FIG. 6 is a block diagram illustrating a machine in the example form of computer system 600, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client Network environments, or it may act as a peer machine in peer-to-peer (or distributed) Network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 600 includes at least one processor 602 (e.g., a central processing unit (CPU), a graphics processing unit (GPU) or both, processor cores, compute nodes, or the like), a main memory 604, and a static memory 606, which communicate with each other via a link 608. The computer system 600 may further include a video display unit 610, an input device 612 (e.g., a keyboard), and a user interface UI navigation device 614 (e.g., a mouse). In one embodiment, the video display unit 610, input device 612, and UI navigation device 614 are incorporated into a single device housing such as a touch screen display. The computer system 600 may additionally include a storage device 616 (e.g., a drive unit), a signal generation device 618 (e.g., a speaker), a network interface device 620, and one or more sensors (not shown), such as a global positioning system (GPS) sensor, compass, accelerometer, or other sensors.

The storage device 616 includes a machine-readable medium 622 on which is stored one or more sets of data structures and instructions 624 (e.g., software) embodying or utilized by any one or more of the methodologies or functions described herein. The instructions 624 may also reside, completely or at least partially, within the main memory 604, the static memory 606, and/or within the processor 602 during execution thereof by the computer system 600, with the main memory 604, the static memory 606, and the processor 602 also constituting machine-readable media.

While the machine-readable medium 622 is illustrated in an example embodiment to be a single medium, the term “machine-readable medium” may include a single medium or multiple media (e.g., a centralized or distributed database, and/or associated caches and servers) that store the one or more instructions 624. The term “machine-readable medium” shall also be taken to include any tangible medium that is capable of storing, encoding, or carrying instructions for execution by the machine and that causes the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. A computer-readable storage device may be a machine-readable medium 622 that excluded transitory signals.

The instructions 624 may further be transmitted or received over a communications network 626 using a transmission medium via the network interface device 620 utilizing any one of a number of well-known transfer protocols (e.g., HTTP). Examples of communication networks include a Local Area Network (LAN), a Wide Area Network (WAN), the Internet, mobile telephone networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

Example 1 is a method comprising: receiving, at a routing platform, an ongoing voice call; generating, at the routing platform, an interaction identifier associated with a user and the ongoing voice call; collecting, from a user device of the user, ongoing voice call information; retrieving, using the ongoing voice call information, a user data record from a records data storage; identifying a target routing platform based on the user data record and the ongoing voice call information; and sending a voice stream corresponding to the ongoing voice call to the target routing platform, the target routing platform including a routing target.

In Example 2, the subject matter of Example 1 includes, before retrieving the user data record from the records data storage, authenticating the user based on the ongoing voice call information.

In Example 3, the subject matter of Examples 1-2 includes, wherein collecting the ongoing voice call information includes collecting information using a chatbot.

In Example 4, the subject matter of Examples 1-3 includes, wherein the routing target includes at least one of an artificial intelligence agent, a human agent, or a voicemail.

In Example 5, the subject matter of Examples 1-4 includes, identifying, using the ongoing voice call information, the user, wherein identifying the user includes identifying a user account number and a user intent.

In Example 6, the subject matter of Examples 1-5 includes, sending status requests for routing target statuses to a plurality of routing platforms; and receiving a plurality of routing target statuses, each routing target status of the plurality of routing target statuses corresponding to a respective routing platform of the plurality of routing platforms, wherein identifying the target routing platform is further based on the plurality of routing target statuses.

In Example 7, the subject matter of Examples 1-6 includes, wherein receiving, at the routing platform, the ongoing voice call is via a first public carrier, and sending the voice stream corresponding to the ongoing voice call to the target routing platform is via a second public carrier.

In Example 8, the subject matter of Examples 1-7 includes, sending the user data record of the user to the target routing platform.

In Example 9, the subject matter of Example 8 includes, before sending the voice stream to the target routing platform, receiving a confirmation that a data record identified by the interaction identifier was created at a temporary data storage.

Example 10 is a method comprising: receiving, at a routing platform, a voice stream including an interaction identifier related to an ongoing voice call and a user; sending, to a temporary data store, a data request for a temporary data record, the data request including the interaction identifier from the voice stream; receiving, from the temporary data store, the temporary data record related to the ongoing voice call; determining a routing target based on the temporary data record; and routing the ongoing voice call and the temporary data record to the routing target.

In Example 11, the subject matter of Example 10 includes, after receiving the temporary data record, authenticating the user based on one or more parameters of the temporary data record; and associating, in response to authenticating the user, the temporary data record with the ongoing voice call.

In Example 12, the subject matter of Example 11 includes, wherein authenticating the user includes authenticating the user without using the interaction identifier.

In Example 13, the subject matter of Examples 10-12 includes, wherein the routing target includes at least one of an artificial intelligence agent, a human agent, or a voicemail.

In Example 14, the subject matter of Examples 10-13 includes, before receiving the voice stream from a second routing platform, sending a target status to the second routing platform.

In Example 15, the subject matter of Examples 10-14 includes, sending, to the temporary data store, a request to delete the temporary data record; and receiving, from the temporary data store, a confirmation that the temporary data record was deleted.

Example 16 is a system comprising: at least one processor; and memory including

instructions that, when executed by the at least one processor, cause the at least one processor to: receive, at a routing platform, a voice stream including an interaction identifier related to a user and an ongoing voice call; send a data request for a data record to a temporary data store, the data request including the interaction identifier from the voice stream; receive the data record from the temporary data store, the data record related to the user and the ongoing voice call; and route the ongoing voice call and the data record to a routing target.

In Example 17, the subject matter of Example 16 includes, authenticate the user based on the data record; and associate, in response to authentication of the user, the data record with the ongoing voice call.

In Example 18, the subject matter of Examples 16-17 includes, wherein the routing target includes at least one of an artificial intelligence agent, a human agent, or a voicemail.

In Example 19, the subject matter of Examples 16-18 includes, before route the ongoing voice call and the data record to the routing target, identify the routing target based on the data record.

In Example 20, the subject matter of Examples 16-19 includes, cause the at least one processor to: send, to the temporary data store, a request to delete the data record from the temporary data store; and receive, from the temporary data store, a confirmation that the data record was deleted.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

What is claimed is:

1. A method comprising:
receiving, at a routing platform, an ongoing voice call;
generating, at the routing platform, an interaction identifier associated with a user and the ongoing voice call;
collecting, from a user device of the user, ongoing voice call information;
retrieving, using the ongoing voice call information, a user data record from a records data storage;
identifying a target routing platform based on the user data record and the ongoing voice call information; and
sending a voice stream corresponding to the ongoing voice call to the target routing platform, the target routing platform including a routing target.

2. The method of claim 1, further comprising:
before retrieving the user data record from the records data storage, authenticating the user based on the ongoing voice call information.

3. The method of claim 1, wherein collecting the ongoing voice call information includes collecting information using a chatbot.

4. The method of claim 1, wherein the routing target includes at least one of an artificial intelligence agent, a human agent, or a voicemail.

5. The method of claim 1, further comprising:
identifying, using the ongoing voice call information, the user, wherein identifying the user includes identifying a user account number and a user intent.

6. The method of claim 1, further comprising:
sending status requests for routing target statuses to a plurality of routing platforms; and
receiving a plurality of routing target statuses, each routing target status of the plurality of routing target statuses corresponding to a respective routing platform of the plurality of routing platforms, wherein identifying the target routing platform is further based on the plurality of routing target statuses.

7. The method of claim 1, wherein receiving, at the routing platform, the ongoing voice call is via a first public carrier, and sending the voice stream corresponding to the ongoing voice call to the target routing platform is via a second public carrier.

8. The method of claim 1, further comprising:
sending the user data record of the user to the target routing platform.

9. The method of claim 8, further comprising:
before sending the voice stream to the target routing platform, receiving a confirmation that a data record identified by the interaction identifier was created at a temporary data storage.

10. A method comprising:
receiving, at a routing platform, a voice stream including an interaction identifier related to an ongoing voice call and a user;
sending, to a temporary data store, a data request for a temporary data record, the data request including the interaction identifier from the voice stream;
receiving, from the temporary data store, the temporary data record related to the ongoing voice call;
determining a routing target based on the temporary data record; and
routing the ongoing voice call and the temporary data record to the routing target.

11. The method of claim 10, further comprising:
after receiving the temporary data record, authenticating the user based on one or more parameters of the temporary data record; and
associating, in response to authenticating the user, the temporary data record with the ongoing voice call.

12. The method of claim 11, wherein authenticating the user includes authenticating the user without using the interaction identifier.

13. The method of claim 10, wherein the routing target includes at least one of an artificial intelligence agent, a human agent, or a voicemail.

14. The method of claim 10, further comprising:
before receiving the voice stream from a second routing platform, sending a target status to the second routing platform.

15. The method of claim 10, further comprising:
sending, to the temporary data store, a request to delete the temporary data record; and
receiving, from the temporary data store, a confirmation that the temporary data record was deleted.

16. A system comprising:
at least one processor; and
memory including instructions that, when executed by the at least one processor, cause the at least one processor to:
receive, at a routing platform, a voice stream including an interaction identifier related to a user and an ongoing voice call;
send a data request for a data record to a temporary data store, the data request including the interaction identifier from the voice stream;
receive the data record from the temporary data store, the data record related to the user and the ongoing voice call; and
route the ongoing voice call and the data record to a routing target.

17. The system of claim 16, further comprising:
authenticate the user based on the data record; and
associate, in response to authentication of the user, the data record with the ongoing voice call.

18. The system of claim 16, wherein the routing target includes at least one of an artificial intelligence agent, a human agent, or a voicemail.

19. The system of claim 16, further comprising:
before route the ongoing voice call and the data record to the routing target, identify the routing target based on the data record.

20. The system of claim 16, further cause the at least one processor to:
send, to the temporary data store, a request to delete the data record from the temporary data store; and
receive, from the temporary data store, a confirmation that the data record was deleted.
